(19) United States
(12) Patent Application Publication
(10) Pub. No.: US 2008/0041426 A1
(43) Pub. Date: Feb. 21, 2008

(54) Device for Washing Vehicle Wheels

(76) Inventor: Arne Hjorth Hansen, Skanderborg (DK)

Correspondence Address: CANTOR COLBURN, LLP, 55 GRIFFIN ROAD SOUTH, BLOOMFIELD, CT, 06002, US

(21) Appl. No.: 11/628,526

(22) PCT Filed: Jun. 6, 2005
(86) PCT No.: PCT/DK05/00373

§ 371 Date: Sep. 26, 2007

(30) Foreign Application Priority Data
Jun. 7, 2004 (DK) PA 2004 00890

(51) Int. Cl. B08B 13/00

(52) U.S. Cl. 134/45

(57) ABSTRACT

A device is disclosed for washing vehicle wheels with a rim and a tyre mounted thereon, comprising a supporting member for supporting a wheel, so that the wheel may rotate about its axis of symmetry, and means for driving a rotation of the wheel about said axis of symmetry in alternating directions during the washing of a wheel. A water nozzle provides a jet of water at high pressure towards a side surface of the wheel and the point of impingement of the jet of water on the side surface of the wheel is displaced in a radial direction along the wheel.

The present invention relates to a device for washing of vehicle wheels comprising a rim and a tyre mounted thereon, wherein the wheels are dismounted from the vehicle.

### BACKGROUND

Vehicle wheels that have been dismounted from vehicles in the process of maintenance of the vehicle are normally washed before service is performed on the wheels and they are remounted on the vehicle, and so are wheels when they in cold regions are changed twice a year between summer tyres and snow tyres. The washing process may be undertaken manually, but for larger service and maintenance facilities, machines or devices for washing the wheels are used.

In U.S. Pat. No. 6,672,317 by Wohigemuth, a cleaning device is disclosed, wherein the wheel is lowered into a bath of a cleaning fluid, which is heated and placed in a turbulent state by an ultrasound vibrator, whereby the wheel is cleaned efficiently. Other known devices includes boxes in which the wheel is situated and is cleaned with one or more high-flow jets of water, which may be admixed with plastic balls or the like for a more efficient cleaning of the wheel. The jets may be mounted on a rotating carrier, or the wheel may be rotated during the washing process as disclosed in JP 2003-212097 by Suzuki and Matsunaga.

A drawback of these known devices is, that the water consumption for each wash is high as an amount of water of about 100 litres is required for a thorough cleaning of the wheel. The water may be reused a number of times and be filtered between the washings, but an amount of very fine dust from the brakes are cleaned from the wheels and into the water and cannot be removed easily from the water, resulting in dark spots or streaks on the rims of the subsequently washed wheels, which is less desired.

In WO 90/11210 and DE 2325484, devices are disclosed in which wheels are rotated in an upright position while a jet of water is moved along the sides surface thereof. However, the outcome of the washing process is not satisfactory unless an amount of water similar to the previously discussed devices is applied with the same drawbacks.

Thus, it is an object of the present invention to provide a device for washing vehicle wheels with reduced water consumption, so that reuse of the washing water may be made redundant.

This object is reached with the device according to claim 1, in which the wheel is rotated about its axis of symmetry in alternating directions of rotation while a jet of water at high pressure is provided towards a side surface of the wheel. In order to reduce the water consumption, the device comprises means for displacing the point of impingement of the jet of water on the side surface of the wheel in a radial direction along the wheel, so that the water jet reaches the whole side surface during the washing process. Thereby, a very efficient use of the water may be achieved as no or very little spreading of the water jet is required to reach the whole side surface, and the water consumption may be lowered to below 15 litres for one wash or even to 5-10 litres while a thorough cleaning of the wheel is still obtained.

Another drawback of the known devices is that although the known devices perform the washing process automatically, a satisfactory arrangement that allows for automation or semi-automation of the loading and unloading of the wheels into and from the devices has not been found previously. Thus, it is another object of the present invention to provide a device in which automation or semi-automation of the loading and unloading of the wheels into and from the devices is facilitated while a thorough cleaning of the wheel still may be obtained.

This object is achieved by the device according to claim 18, which comprises a conveyance member to receive and support a wheel in a horizontal position from a side of the device and deliver it to a side of the device also in a horizontal position. A wheel in its horizontal position is much more stable than a vertically positioned wheel standing on the thread of the tyre and is therefore more suited for automated or semi-automated handling. However, the lower side surface of the wheel needs to be accessible for washing for which reason the present device is equipped with a supporting member for supporting the rim of the wheel from below, so that the wheel is in a substantially horizontal position, and the device is furthermore equipped with means for lowering the conveyance member, so that a wheel supported thereby will be supported solely by said supporting member when the conveyance member is lowered. Thereby, the conveyance member may be lowered away from the lower side surface, which may be washed by washing means, optionally when rotated as discussed above, so that a water jet may be applied in a similar manner with reduced water consumption as a consequence.

Other advantages of the present invention and specific embodiments thereof will be apparent from the following description.

### BRIEF DESCRIPTION OF THE INVENTION

Thus, the present invention relates in a first aspect to a device for washing vehicle wheels with a rim and a tyre mounted thereon, the device comprising
a supporting member for supporting a wheel, so that the wheel may rotate about its axis of symmetry,
means for driving a rotation of the wheel about said axis of symmetry, said means being arranged to change the direction of rotation of the wheel during operation of the device for the washing of a wheel,
water nozzle for providing a jet of water at high pressure towards a side surface of the wheel,
displacement means for displacing the point of impingement of the jet of water on the side surface of the wheel in a radial direction along the wheel,
water providing means for providing water at a high pressure to said water nozzle, and
control means for controlling the operation of the device, so that a wheel placed in the device rotates when the water nozzle is displaced by said displacement means and the pressurising means provides water to said water nozzle.

By reversing or alternating the direction of rotation, the water and/or detergent that is applied during rotation of the wheel in both directions is ensured to entrain into all details of the tyre and the rim of the wheel. The means for driving the rotation are preferably arranged to reverse the direction of rotation of the wheel several times during a washing operation of a wheel.

The supporting member is preferably a centre-supporting member, such as e.g. a cone that may be passed into the orifice in the centre of the rim, and preferably arranged for supporting the wheel in a horizontal position thereof.

The water nozzle is preferably arranged to provide the jet of water at a tangential angle to the normal of the side surface of the wheel so that the jet of water has a tangential component opposing the direction of rotation of the wheel, and comprises means to alter said angle to an angle in the opposite tangential direction during operation of the device so that the water jet has a direction against the direction of rotation of the wheel, which causes an improved effect of the water jet, wherein said means are controlled by the control means to alter said angle with the change in direction of rotation of the wheel. The tangential angles of the water jet are preferably within the range of 20° to 40° to said side surface normal. With such an arrangement, the water jet may in a particular embodiment drive a rotation of the wheel, the angle may then be altered, which again may drive the wheel to a rotation in the opposite direction, the direction of the water jet may be altered again and this cycle may be repeated one or two times or even more, so that a satisfactory result of the cleaning may be achieved.

It is also preferred that the water nozzle during operation is kept within a distance of 2.5 to 12 centimetres, preferably within a distance of 4 to 8 centimetres, to the side surface of the wheel The distance is measured in the direction of the jet, i.e. the distance the water travels from the opening of the nozzle and to the side surface of the wheel.

The point of impingement of the water jet may be adjusted by rotating the water nozzle or by directing the water nozzle with an angle to the wheel side normal, so that the impingement point may be adjusted by displacing the nozzle in the direction normal to at least one side surface, preferably the upper one. However, it is advantageous that said displacement means comprises means for displacing the water nozzle in a radial direction along the wheel, preferably along the upper side surface of the wheel for the washing thereof. Thereby, it is facilitated to displace other parts, such as an air nozzle or a detergent nozzle together with the water nozzle as discussed below.

The pressurising means are preferably suitable for providing water at a pressure in the range of 60-200 bars, preferably in the range of 65-140 bars and most preferred in the range of 70-130 bars.

Furthermore, the device may advantageously comprise heating means for heating the water provided to the water nozzle to a temperature in the range of 60° C. to 90° C., preferably in the range of 65° C. to 80° C., so as to ensure a thorough cleaning as well as a fast and complete drying of the wheel when it is unloaded form the device. Such high temperatures are obtainable together with high-pressure pumps used with the present invention where only a low flow rate is required, whereas the high flow pumps with low delivery pressure normally used in the known devices cannot withstand such high temperature unless they are of a very expensive quality. The higher temperature prevents that the wheels have residual water when they are removed from the device, whereby spillage of water on the workshop floor and on the operator is prevented.

In order to assist the drying of the wheel, the device may comprise drying means for drying said side surface of the wheel subsequent to the washing of the wheel by means of one or more jets of compressed air and air providing means for providing pressurised air to the drying means.

The drying means may in particular comprise an air nozzle, which may be displaced together with the water nozzle by means of the displacement means displacing the water jet in a radial direction. In particular, the drying means may be arranged so that at least one jet of compressed air impinges on the wheel at a tangential angle to the side surface normal, so as to constitute said means for driving a rotation of the wheel about said axis of symmetry.

The drying means may in particular comprise an air nozzle which is arranged to provide a jet of air at a tangential angle to the normal of the side surface of the wheel so that the jet of air has a tangential component opposing the direction of rotation of the wheel, and comprises means to alter said angle to an angle in the opposite tangential direction during operation of the device, wherein said means are controlled by the control means to alter said angle with the change in direction of rotation of the wheel. The tangential angles of the air jet are preferably within the range of 20° to 40° to said side surface normal.

Furthermore, the device may comprise detergent applying means for providing a liquid detergent to said side surface of the wheel prior to application of the water jet by means of the water nozzle, and detergent providing means for providing liquid detergent under pressure to the detergent applying means. The detergent applying means may comprise a detergent nozzle, which may be displaced together with the water nozzle by means of the displacement means displacing the water jet in a radial direction. The detergent applying means may be arranged to provide a jet of detergent at a tangential angle to the normal of the side surface of the wheel so that the jet of detergent has a tangential component opposing the direction of rotation of the wheel, and comprises means to alter said angle to an angle in the opposite tangential direction during operation of the device, wherein said means are controlled by the control means to alter said angle with the change in direction of rotation of the wheel. The tangential angles of the detergent jet are preferably within the range of 20° to 40° to said side surface normal.

The means for driving the rotation of the wheel comprises in a preferred embodiment a motor, such as an electrical, a hydraulic or a pneumatic motor, which is arranged to drive the wheel with a rotational speed within the range of 40 to 100 rotations per minute, preferably within the range of 55 to 85 rotations per minute. Thereby, a complete treatment of the wheel with detergent, water and/or air may be performed rather quickly.

According to an aspect of the present invention, a device is provided for washing vehicle wheels with a rim and a tyre mounted thereon, the device comprising
a conveyance member arranged to receive and support a wheel in a substantially horizontal position thereof from a side of the device and deliver it to a side of the device in a substantially horizontal position,
a supporting member for supporting the rim of the wheel from below, so that the wheel is in a substantially horizontal position,
means for lowering said conveyance member, so that a wheel supported thereby will be supported solely by said supporting member when the conveyance member is lowered,
washing means for washing the upper as well as the lower side surface of said wheel, and
control means for controlling the operation of the device, so that the conveyance member is lowered before a wheel supported thereby is washed by said washing means.

The conveyance member is advantageously arranged to receive a wheel from and deliver the wheel to substantially opposing sides of the device, so that the device may be included in an automated or semi-automated line for handling the wheels. The conveyance member may comprise passive conveyance means, such as rollers or balls that the wheel is supported by, so that the wheel easily may slide into and from the device manually or by being pushed by means of a succeeding wheel, or it may comprise active conveyance means, such as driven rollers, a conveyor belt or chain or the like. The conveyance member may in particular be arranged to receive a wheel and deliver the wheel at substantially the same vertical level, and the means for lowering said conveyance member may also be arranged to elevate the conveyance member subsequently to the washing of the wheel, so as to lift the wheel off the supporting member to a position in which it is delivered from the device. In case the device is arranged in a line for automatic or semi-automatic handling of wheel, wheels which for some reason is not in need of washing may easily pass through the device without being washed and without hindering the flow in the handling line.

The device according to this aspect may be combined with any of the features of the device according to the previously mentioned first aspect of the present invention.

### BRIEF DESCRIPTION OF THE DRAWINGS

An embodiment of a device in accordance with the present invention is shown in the accompanying drawing for illustration of the invention without limiting the scope of protection.

FIG. 1 shows a side view of the device arranged between a first table for holding the wheels to be fed into the device and a second table for receiving the wheels subsequent to the washing,

FIG. 2 is a perspective view of the device as seen from above,

FIG. 3 is a perspective view of the device as seen from below,

FIG. 4a is a side view of the device with cut-off parts of the outer housing, and

FIG. 4b is a cross-sectional view as taken along the line A-A in FIG. 4a.

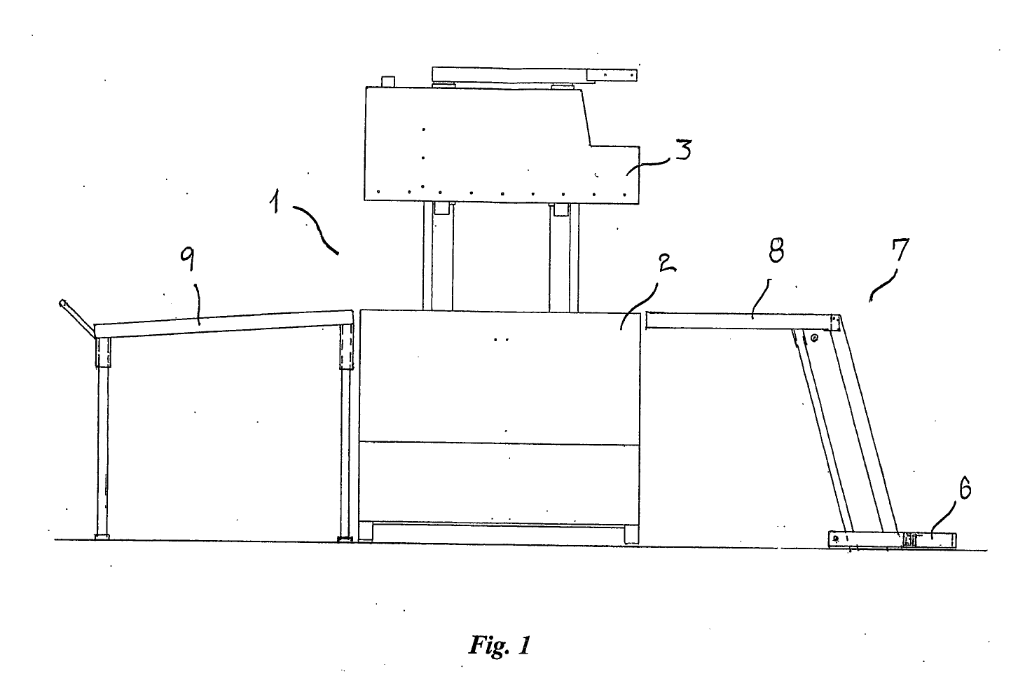

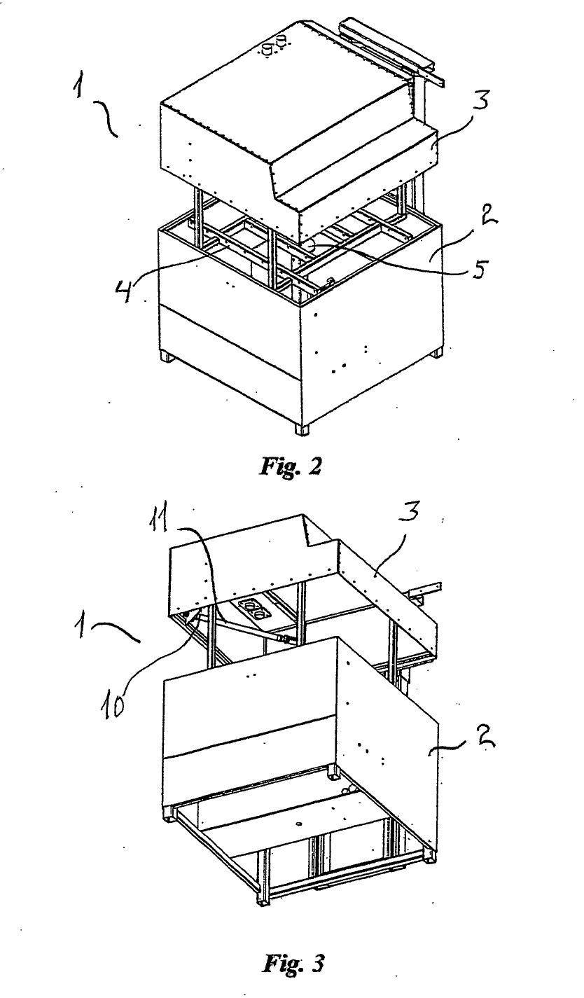

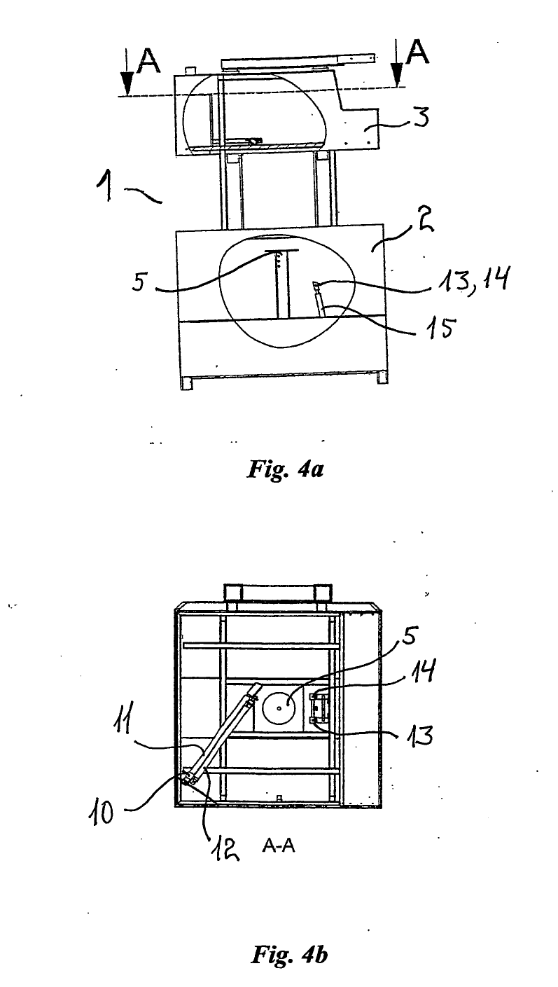

### EMBODIMENTS OF THE PRESENT INVENTION

The device 1 shown in the figures comprises a housing 2 and a lid 3, which may be elevated as shown in the figures to allow a wheel to be placed in the device 1 or to be delivered from the device after the washing thereof, and which may be lowered so that it together with the housing 2 forms a substantially enclosed space in which the washing takes place. A conveyance member 4 carrying a plurality of rollers (not shown) is shown in the figures in its elevated state for receiving or delivering a wheel. Within the housing, a supporting member 5 is arranged for carrying the wheel during the washing by supporting the rim so that the wheel may rotate freely about its vertical axis of symmetry. The operation of the device is as follows:

The wheel is situated with a substantially vertical orientation on the elevating part 6 of the first table 7 upstream of the device 1 in the washing line. When the device is ready, the elevating part 6 is tilted to a horizontal position and the wheel is elevated to the level of the stationary part 8 of the first table 7. The wheel is manually moved from the first table 7 and into the device 1, where it is used to push the washed wheel situated on the conveyance member 4 out from the device and onto the second receiving table 9.

The supporting member 5 is elevated by means of a pneumatic cylinder until it has contact with the rim of the wheel. The top of the supporting member 5 has a conical shape (not shown) for centering the wheel. The conveyance member 4 is lowered by means of a pneumatic cylinder, and the weight of the wheel presses the supporting member 5 down to a lower resting position so that the wheel is in a position to be washed. The conveyance member 4 is lowered further so that the wheel is allowed to rotate freely. Thus, the pneumatic cylinder applied to elevate the supporting member 5 is only required to be able to elevate the supporting member 5 itself without the wheel. Then, the lid 3 is lowered into its closing position and the washing process may begin.

A detergent nozzle, an air nozzle and a water nozzle are situated together on a slide 10 that may be displaced along a guide 11 by means of a pneumatic two-way cylinder 12. The longitudinal direction of the guide 11 has a radial component, so that said nozzles are displaced with a radial component when the cylinder 12 is activated in either direction.

A first device according to the drawings may be operating as follows:

The air nozzle is angled so that the air jet has an angle to the normal to the upper side surface of the wheel of 45° in the tangential direction and the air nozzle is activated while the slide 10 is displaced from the outermost position to the innermost position at the rim by means of the cylinder 12, so that the wheel rotates due to the air jet and all loose debris is removed from the upper side surface of the wheel. The slide 10 with the nozzles is returned to the outermost position by means of the cylinder while the detergent delivering means of the device are activated and detergent is sprayed by means of the detergent nozzle onto the upper side surface of the wheel. A lower detergent nozzle 13 arranged together with a lower water nozzle 14 is elevated by means of a pneumatic cylinder 15. The lower nozzles 13, 14 have an angle of 15 to 300 in the radial direction to the lower side surface normal and when they are moved up and down, the jets from the nozzles may cover the whole radius of the wheel. The lower detergent nozzle 13 is also activated at the same time at the upper one, and the whole wheel is thus covered with a layer of a detergent, which is allowed to be active on the dry wheel for 20-40 seconds, whereby dirt and in particular dust from the brakes is loosened efficiently.

The water providing means and the water heating means are activated to supply water at 70° C. and a pressure of 140 bars to the upper and lower water nozzles. The slide 10 carrying the upper nozzles is displaced toward the rim of the wheel and the lower water nozzle is lowered, so that both surfaces are washed by the water. The upper water nozzle has an angle to the normal to the upper side surface of the wheel of 45° in the tangential direction so that the action of the upper water jet on the wheel causes the wheel to change its direction of rotation. When the upper nozzles have reached the rim of the wheel, the slide is rotated 90° so that the water nozzle has an angle to the normal to the upper side surface of the wheel of 45° in the tangential opposite direction, where after the slide is returned to its outermost position. The slide is returned to the innermost position at the rim while the water jet is still activated, and the slide is rotated 90° to its original position, where after the slide 10 is returned by means of the pneumatic cylinder 12 to the outermost position. The lower water nozzle 14 is moved up and down following the movements back and forth of slide 10 carrying the upper nozzles. Thus, the upper side surface of the wheel is cleaned with a water jet with altering directions and with and against the direction of rotation, which provides an efficient and thorough cleaning with a minimal consumption of water. The cleaning of the lower side surface is less advanced but has proven to be sufficient. However, an arrangement similar to the one on the upper side surface may be applied at the lower side surface if required.

Finally, the air nozzle above the wheel is activated again, and the nozzle is moved back and forth by means of the pneumatic cylinder 12 to blow excessive water from the upper surface of the wheel. The water on the lower surface drips off, and the remaining water evaporates due to the high temperature of the water. Another air nozzle (not shown) is directed towards the thread of the tyre to remove water there from.

A second embodiment of the device according to the present invention is operating as follows:

Firstly, the wheel is driven to a rotational speed of about 70 rotations per minute by means of an electrical motor driving the supporting member 5. The slide 10 with the nozzles is positioned near the centre of the wheel and is moved towards the outermost position by means of the cylinder 12 while the detergent delivering means of the device are activated and detergent is sprayed by means of the detergent nozzle onto the upper side surface of the wheel. The detergent nozzle is turned so that the jet of detergent will have an angle to the normal of the upper side surface of the wheel of about 30° in the tangential direction to the upper surface of the wheel and against the direction of rotation of the wheel, so that the detergent jet and the surface of the wheel moves in opposite directions when they meet, whereby the detergent is ensured to entrain into the details and cavities of the wheel rim. When the slide 10 with the nozzles have reached the outer edge of the wheel, the direction of rotation of the wheel is reversed and the detergent nozzle is turned so that the jet of detergent will still have an angle to the normal of the upper side surface of the wheel of about 30° in the tangential direction to the upper surface of the wheel against the direction of rotation of the wheel, where after the slide 10 is returned to the centre of the wheel during application of detergent to the upper surface of the wheel. By rotation of the wheel in alternating direction and application of detergent with a jet directed against the direction of movement of the surface of the wheel, a complete coverage with detergent of the upper side of the wheel is ensured. A lower detergent nozzle 13 arranged together with a lower water nozzle 14 is elevated by means of a pneumatic cylinder 15. The lower nozzles 13, 14 have an angle of 15 to 500 in the radial direction to the lower side surface normal and when they are moved up and down, the jets from the nozzles may cover the whole radius of the wheel. The lower detergent nozzle 13 is also activated at the same time at the upper one, and the whole wheel is thus covered with a layer of a detergent, which is allowed to be active on the dry wheel for 20-50 seconds, whereby dirt and in particular dust from the brakes is loosened efficiently. In a particular embodiment, the lower water nozzle 14 comprises two nozzle arranged adjacent and ejecting water jets of an angle to the normal of the lower side surface of the wheel of about 20-30° and of about 35-45°, that is with a difference in angle of about 10-20°, so as to clean the whole lower side surface more efficiently.

The water providing means and the water heating means are activated to supply water at 70° C. and a pressure of 140 bars to the upper and lower water nozzles. The slide 10 carrying the upper nozzles is displaced toward the outer edge of the wheel, which is still rotated at about 70 rotations per minute by means of the electrical motor, and the lower water nozzle is lowered, so that both surfaces are washed by the water. The upper water nozzle has an angle to the normal to the upper side surface of the wheel of 30° in the tangential direction ands against the direction of rotation of the wheel. When the upper nozzles are near the outer edge of the wheel, the slide is rotated so that the water nozzle has an angle to the normal to the upper side surface of the wheel of about 300 in the tangential opposite direction. The direction of rotation of the wheel is reversed by means of the electrical motor, where after the slide 10 is returned to its innermost position near the centre of the wheel by means of the pneumatic cylinder 12. The lower water nozzle 14 is moved up and down following the movements back and forth of slide 10 carrying the upper nozzles. Thus, the upper side surface of the wheel is cleaned with a water jet with altering directions against the direction of rotation, which provides an efficient and thorough cleaning with a minimal consumption of water. The water nozzles, i.e. the upper nozzle as well as the lower nozzle 14, are during operation situated at a distance of 4-8 centimetres from the surface of the wheel measured along the direction of the jet. The cleaning of the lower side surface is less advanced but has proven to be sufficient. However, an arrangement similar to the one on the upper side surface may be applied at the lower side surface if required.

Optionally, the slide 10 may comprise a wax nozzle for applying a mixture of water and wax to the rim of the wheel. The wax nozzle is designed to apply the jet of wax and water at an angle to the normal to the upper side surface of the rim of 30° in the tangential direction and against the direction of rotation of the wheel. The wax nozzle may if required be turned while the direction of the rotation of the wheel is reversed, so that the angle to the normal of the upper side surface of the wheel of the jet of water and wax still is about 30° in the tangential direction and directed against the direction of rotation of the wheel.

Finally, the air nozzle above the wheel is activated to produce an air jet having an angle to the normal to the upper side surface of the wheel of about 30° in the tangential direction and against the direction of rotation of the wheel, which is still rotated at 70 rotation per minute. The air nozzle is moved back and forth between the centre and the outer edge of the wheel by means of the pneumatic cylinder 12 to blow excessive water from the upper surface of the wheel. The water on the lower surface drips off, and the remaining water evaporates due to the high temperature of the water. Another air nozzle (not shown) is directed towards the thread of the tyre to remove water there from. As a complete alternative to using the air nozzle to free the wheel from excessive water or for supplying the action of the air nozzle, the wheel-washing device may be arranged with a subsequent tunnel where a flow of hot air dries the remaining water from the surface of the wheel.

When the wheel has been washed, the conveyance member 4 is elevated by means of a pneumatic cylinder and the wheel is lifted off the supporting member 5 and to the starting position. Finally, the lid 3 is elevated automatically by a pneumatic cylinder and the washed wheel may be delivered to the second table 3 by being pushed by the subsequent wheel when it is entered into the device 1. In a particular embodiment, the pneumatic cylinder elevating the lid 3 is at the same time drives the movement of the elevating part 6 which lifts a wheel from a substantially vertical position on or near the floor to a horizontal position, from where it may be moved directly in the washing device.

1. Device for washing vehicle wheels with a rim and a tyre mounted thereon, the device comprising
a supporting member for supporting a wheel, so that the wheel may rotate about its axis of symmetry,
means for driving a rotation of the wheel about said axis of symmetry, said means being arranged to change the direction of rotation of the wheel during operation of the device for the washing of a wheel,
water nozzle for providing a jet of water at high pressure towards a side surface of the wheel,
displacement means for displacing the point of impingement of the jet of water on the side surface of the wheel in a radial direction along the wheel,
water providing means for providing water at a high pressure to said water nozzle, and
control means for controlling the operation of the device, so that a wheel placed in the device rotates when the water nozzle is displaced by said displacement means and the pressurising means provides water to said water nozzle.

2. Device according to claim 1, wherein the water nozzle is arranged to provide the jet of water at a tangential angle to the normal of the side surface of the wheel so that the jet of water has a tangential component opposing the direction of rotation of the wheel, and comprises means to alter said angle to an angle in the opposite tangential direction during operation of the device, wherein said means are controlled by the control means to alter said angle with the change in direction of rotation of the wheel.

3. Device according to claim 2, wherein said tangential angles of the water jet are within the range of 20° to 40° to said side surface normal.

4. Device according to claim 1, wherein the water nozzle operation is kept within a distance of 2.5 to 12 centimetres to the side surface of the wheel.

5. Device according to claim 1, wherein the said displacement means comprises means for displacing the water nozzle in a radial direction along the wheel.

6. Device according to claim 1, wherein said pressurising means provides water at a pressure in the range of 60-200 bars.

7. Device according to claim 1, comprising heating means for heating the water provided to the water nozzle to a temperature in the range of 60° C. to 90° C.

8. Device according to claim 1, comprising drying means for drying said side surface of the wheel subsequent to the washing of the wheel by means of one or more jets of compressed air, and
air providing means for providing pressurised air to the drying means.

9. Device according to claim 8, wherein the drying means comprises an air nozzle, which may be displaced together with the water nozzle by means of the displacement means.

10. Device according to claim 8, wherein the drying means comprises an air nozzle which is arranged to provide a jet of air at a tangential angle to the normal of the side surface of the wheel so that the jet of air has a tangential component opposing the direction of rotation of the wheel, and comprises means to alter said angle to an angle in the opposite tangential direction during operation of the device, wherein said means are controlled by the control means to alter said angle with the change in direction of rotation of the wheel.

11. Device according to claim 8, wherein said tangential angles of the air jet are within the range of 200 to 40° to said side surface normal.

12. Device according to claim 8, wherein said drying means are arranged so that at least one jet of compressed air impinges on the wheel at a tangential angle to the side surface normal, so as to constitute said means for driving a rotation of the wheel about said axis of symmetry.

13. Device according to claim 1, comprising detergent applying means for providing a liquid detergent to said side surface of the wheel prior to application of the water jet by means of the water nozzle, and
detergent providing means for providing liquid detergent under pressure to the detergent applying means.

14. Device according to claim 13, wherein the detergent applying means comprises a detergent nozzle, which may be displaced together with the water nozzle by means of the displacement means.

15. Device according to claim 13, wherein the detergent applying means is arranged to provide a jet of detergent at a tangential angle to the normal of the side surface of the wheel so that the jet of detergent has a tangential component opposing the direction of rotation of the wheel, and comprises means to alter said angle to an angle in the opposite tangential direction during operation of the device, wherein said means are controlled by the control means to alter said angle with the change in direction of rotation of the wheel.

16. Device according to claim 15, wherein said tangential angles of the detergent jet are within the range of 20° to 40° to said side surface normal.

17. Device according to claim 1, wherein the means for driving the rotation of the wheel comprises a motor, which is arranged to drive the wheel with a rotational speed within the range of 40 to 100 rotations per minute, preferably within the range of 55 to 85 rotations per minute.

18. Device for washing vehicle wheels with a rim and a tyre mounted thereon, the device comprising
a conveyance member arranged to receive and support a wheel in a substantially horizontal position thereof from a side of the device and deliver it to a side of the device in a substantially horizontal position,
a supporting member for supporting the rim of the wheel from below, so that the wheel is in a substantially horizontal position,
means for lowering said conveyance member, so that a wheel supported thereby will be supported solely by said supporting member when the conveyance member is lowered,
washing means for washing the upper as well as the lower side surface of said wheel, and
control means for controlling the operation of the device, so that the conveyance member is lowered before a wheel supported thereby is washed by said washing means.

19. Device according to claim 18, wherein the conveyance member is arranged to receive a wheel and deliver the wheel from and to substantially opposing sides of the device.

20. Device according to claim 18, wherein the conveyance member is arranged to receive a wheel and deliver the wheel at a substantially same vertical level.

21. Device according to claim 18, further having the features of claim 1.
